(19) United States
(12) Patent Application Publication
(10) Pub. No.: US 2024/0023552 A1
(43) Pub. Date: Jan. 25, 2024

(54) LIQUID PESTICIDAL FORMULATION

(71) Applicant: SUMITOMO CHEMICAL COMPANY, LIMITED, Chuo-ku (JP)

(72) Inventor: Iki TAKETANI, Takarazuka-shi (JP)

(73) Assignee: SUMITOMO CHEMICAL COMPANY, LIMITED, Chuo-ku (JP)

(21) Appl. No.: 18/255,005

(22) PCT Filed: Nov. 30, 2021
(86) PCT No.: PCT/JP2021/043753

§ 371 Date: May 30, 2023

(30) Foreign Application Priority Data
Dec. 1, 2020 (JP) 2020-199855

(51) Int. Cl. A01N 43/54; A01N 43/84; A01N 33/22; A01N 25/02; A01P 13/00

(52) U.S. Cl. CPC A01N 43/54; A01N 43/84; A01N 33/22; A01N 25/02; A01P 13/00

(57) ABSTRACT

A liquid composition comprises two or more pesticidal active compounds, a hydrophobic organic solvent, a first surfactant and water. The two or more pesticidal active compounds are a first ingredient which is a compound represented by the following formula (I), and second ingredient consisting of one or more pesticidal active compounds that differ from the first ingredient, are poorly water-insoluble, and are solid at a temperature of 25° C. The first surfactant is a polyoxyethylene polyoxypropylene block copolymer. In the liquid composition, a liquid with the first ingredient dissolved or suspended in the hydrophobic organic solvent is dispersed in the water, and one or more pesticidal active compounds of the pesticidal active compounds included in the second ingredient are suspended in the water:

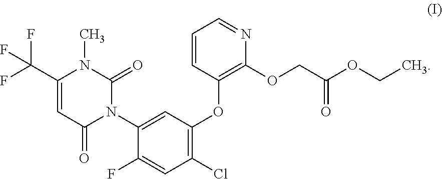

### TECHNICAL FIELD

The present invention relates to a liquid pesticidal formulation.

### BACKGROUND ART

A suspoemulsion in which a liquid pesticidal ingredient including the first pesticidal active compound is dispersed in water and a solid pesticidal ingredient including the second pesticidal active compound is suspended therein is known as a pesticidal formulation containing two pesticidal active compounds (see e.g., WO 2015/024410 (Patent Literature 1)).

A compound represented by the following formula (I), which is an active ingredient for herbicides, is known as a pesticidal active ingredient (see e.g., U.S. Pat. No. 6,537,948 (Patent Literature 2)).

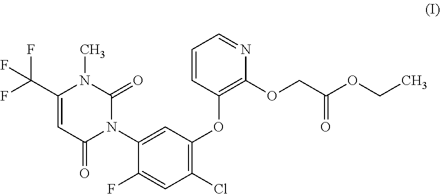

### CITATION LIST

### Patent Literature

PTL 1: WO 2015/024410
PTL 2: U.S. Pat. No. 6,537,948

### SUMMARY OF INVENTION

### Technical Problem

An object of the present invention is to provide a liquid pesticidal formulation which is a liquid composition including two or more pesticidal active compounds, wherein the aggregation of pesticidal active compounds is prevented.

### Solution to Problem

The present invention provides the following liquid composition.

[1] A liquid composition comprising two or more pesticidal active compounds, a hydrophobic organic solvent, a first surfactant and water, wherein
the two or more pesticidal active compounds are a first ingredient which is a compound represented by the following formula (I), and a second ingredient consisting of one or more pesticidal active compounds that differ from the first ingredient, are poorly water-insoluble, and are solid at a temperature of 25° C.,
the first surfactant is a polyoxyethylene polyoxypropylene block copolymer, and
a liquid with the first ingredient dissolved or suspended in the hydrophobic organic solvent is dispersed in the water, and one or more pesticidal active compounds of the pesticidal active compounds included in the second ingredient are suspended in the water:

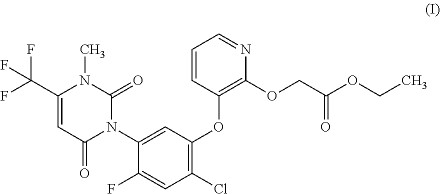

[2] The liquid composition according to [1], wherein all the pesticidal active compounds included in the second ingredient are suspended in the water.

[3] The liquid composition according to [1] or [2], wherein the second ingredient comprises one or more pesticidal active compounds selected from the following group (A):
group (A): the group consisting of flumioxazin and mesotrione.

[4] The liquid composition according to any of [1] to [3], wherein the hydrophobic organic solvent comprises at least one of an aromatic hydrocarbon and benzyl acetate.

[5] The liquid composition according to any of [1] to [4], further comprising a second surfactant, wherein
the second surfactant comprises one or more surfactants selected from the following group (B):
group (B): the group consisting of acrylic acid-based polymers and salts thereof, ligninsulfonate, and salts of formalin condensates of naphthalenesulfonic acids optionally having an alkyl group.

### Advantageous Effects of Invention

According to the present invention, it is made possible to provide a liquid pesticidal formulation wherein the aggregation of pesticidal active compounds is prevented.

### DESCRIPTION OF EMBODIMENTS

A liquid composition according to the present invention (hereinafter, also called “composition of the present invention”) includes two or more pesticidal active compounds, a hydrophobic organic solvent, a first surfactant and water. The pesticidal active compounds are a first ingredient which is a compound represented by the above formula (I) (hereinafter, also called “compound (I)”), and a second ingredient consisting of one or more pesticidal active compounds that differ from the first ingredient, are poorly water-insoluble and, are solid at a temperature of 25° C. The first surfactant is a polyoxyethylene polyoxypropylene block copolymer.

In the composition of the present invention, a liquid with the first ingredient dissolved or suspended in the hydrophobic organic solvent is dispersed in the water, and one or more pesticidal active compounds of the pesticidal active compounds included in the second ingredient are suspended in the water. The composition of the present invention is a suspoemulsion in which a continuous phase is an aqueous phase and liquid particles and solid particles are dispersed in the continuous phase. The first ingredient is contained in the liquid particles, and the solid particles are at least one of the pesticidal active compounds included in the second ingredient.

The two or more pesticidal active compounds contained in the composition of the present invention are a first ingredient which is a compound (I), and a second ingredient which is one or more pesticidal active compounds other than the compound (I).

The compound (I) serving as the first ingredient is a known compound and has an excellent herbicidal efficacy. The compound (I) can be synthesized by, for example, a method described in Patent Literature 1. The compound (I) is a solid at a temperature of 25° C., and the compound (1) in the composition of the present invention is present in a state dissolved or suspended in the hydrophobic organic solvent.

The content of the first ingredient in the composition of the present invention is usually 0.01 wt % or more, preferably 0.05 wt % or more, more preferably 0.1 wt % or more, further preferably 0.3 wt % or more. The content of the first ingredient in the composition of the present invention is usually 30 wt % or less, preferably 20 wt % or less, more preferably 15 wt % or less, further preferably 10 wt % or less.

The second ingredient is one or more pesticidal active compounds that are poorly water-insoluble, are solid at a temperature of 25° C., and are one or more pesticidal active compounds differing from the first ingredient. The poorly water-insoluble pesticidal active compound herein refers to a pesticidal active compound having a solubility of 1 g or less per 1 L of water at a temperature of 25° C. The second ingredient is not particularly limited as long as it is one or more pesticidal active compounds that are poorly water-insoluble and are solid at a temperature of 25° C.

A preferable second ingredient is a herbicidal active compound. Examples of the herbicidal active compound included in the second ingredient include flumioxazin, mesotrione, pyroxasulfone, simetryn, daimuron, propanil, mefenacet, fentrazamide, etobenzanid, swep, oxaziclomefone, pyrazolate, prodiamine, cafenstrole, pentoxazone, clomeprop, pyriftalid, benzobicyclon, bromobutide, imazosulfuron, propyrisulfuron, flumiclorac-pentyl, lactofen, flufenacet, rimsulfuron, isoxaflutole, chlorimuron-ethyl, thifensulfuron-methyl, and cloransulam-methyl.

Among them, it is preferable that the second ingredient is one or more pesticidal active compounds selected from the following group (A):
group (A): the group consisting of flumioxazin and mesotrione.

Flumioxazin is a known compound. Flumioxazin can be synthesized by, for example, a method described in Japanese Patent Laying-Open Nos. 61-76486 and 5-97848.

Mesotrione is a known compound. Mesotrione can be synthesized according to, for example, a literature described in The Pesticide Manual Fifteenth Edition (2009), British Crop Production Council (ISBN:978-1-901396-18-8).

The content of the second ingredient in the composition of the present invention is usually 0.01 wt % or more, preferably 0.1 wt % or more, more preferably 0.5 wt % or more, further preferably 1 wt % or more. The content of the second ingredient in the composition of the present invention is usually 40 wt % or less, preferably 30 wt % or less, more preferably 20 wt % or less. When the second ingredient is two or more pesticidal active compounds, the content of the second ingredient refers to the total content thereof.

The composition of the present invention may further contain a herbicidal active compound in addition to the pesticidal active compounds described above. Examples of the herbicidal active compound that may further be contained include glyphosate potassium salt, glyphosate dimethylamine salt, glyphosate monoethanolamine salt, glufosinate ammonium salt, glufosinate P ammonium salt, glyphosate isopropylammonium salt, 2,4-D choline salt, 2,4-D dimethylamine salt, dicamba diglycolamine salt, dicamba BAPMA salt, dicamba tetrabutylamine salt, dicamba tetrabutylphosphonium salt, clethodim, S metolachlor, metribuzin, nicosulfuron, acetochlor, and imazethapyr ammonium salt.

The composition of the present invention contains a hydrophobic organic solvent. The hydrophobic organic solvent herein refers to an organic solvent having a water solubility of 10 wt % or less at a temperature of 25° C. The hydrophobic organic solvent is not particularly limited as long as it is an organic solvent that can dissolve or suspend the compound (I). Also, two or more hydrophobic organic solvents may be mixed and used.

Examples of the hydrophobic organic solvent include:
alcohols such as hexanol, heptanol, and octanol;
esters such as methyl caproate, methyl caprylate, methyl caprate, methyl laurate, methyl myristate, methyl palmitate, methyl stearate, methyl oleate, methyl linoleate, ethyl acetate, butyl acetate, hexyl acetate, octyl acetate, benzyl acetate, methyl benzoate, ethyl benzoate, butyl benzoate, dimethyl phthalate, diethyl phthalate, diethyl oxalate, dioctyl succinate, methyl salicylate, dimethyl adipate, dibutyl adipate, tert-butyl acetoacetate and allyl acetoacetate;
ethers such as propylene glycol phenyl ether;
ketones such as acetophenone;
amides such as N,N-dimethyldecanamide, N,N-dimethyldodecanamide, N,N-dimethyltetradecanamide, and N,N-dimethyloctadecanamide, lactams such as N-octyl-pyrrolidone, N-decyl-pyrrolidone, and N-dodecyl-pyrrolidone;
aliphatic hydrocarbons such as hexane, octane, decane, tridecane, tetradecane, hexadecane, octadecane, normal paraffin, isoparaffin, cycloparaffin, 1-undecene and 1-heneicosene;
aromatic hydrocarbons such as toluene, xylene, ethylbenzene, alkylnaphthalenes (e.g., methylnaphthalene, dimethylnaphthalene, dodecyl naphthalene and tridecylnaphthalene), and mixtures thereof;
fatty acids such as caproic acid, caprylic acid, capric acid, oleic acid, linoleic acid and enanthic acid;
animal- or vegetable-derived oils such as olive oil, soybean oil, rape oil, castor oil, linseed oil, cottonseed oil, palm oil, avocado oil, coconut oil, and shark liver oil; and
mineral oils such as machine oil.

Preferable examples of the hydrophobic organic solvent include benzoic acid esters such as methyl benzoate, ethyl benzoate, butyl benzoate, and benzyl benzoate, aromatic hydrocarbons and benzyl acetate, more preferably aromatic hydrocarbons and benzyl acetate.

The content of the hydrophobic organic solvent in the composition of the present invention is preferably 1 wt % or more, more preferably 5 wt % or more, and may be 10 wt % or more, and is preferably 50 wt % or less, more preferably 40 wt % or less, and may be 30 wt % or less and may be 25 wt % or less. When two or more hydrophobic organic solvents are contained, the content of the hydrophobic organic solvent refers to the total content thereof.

The content of the organic solvent of an aromatic hydrocarbon and/or benzyl acetate in the content of the hydrophobic organic solvent in the composition of the present invention is preferably 30 wt % or more, more preferably 50 wt % or more, and may be 70 wt % or more, may be 90 wt % or more, and may be 100 wt %.

The composition of the present invention may contain an organic solvent other than the hydrophobic organic solvent.

The composition of the present invention contains a polyoxyethylene polyoxypropylene block copolymer as a first surfactant. The HLB value of the polyoxyethylene polyoxypropylene block copolymer according to the Griffin method is preferably 5 or more, more preferably 6 or more, and may be 7 or more. It is preferably 18 or less, more preferably 17 or less, and may be 16 or less. The average molecular weight of the polyoxyethylene polyoxypropylene block copolymer is preferably 2000 or higher, more preferably 3000 or higher, and may be 4000 or higher. It is preferably 15000 or lower, more preferably 14000 or lower, and may be 13000 or lower. The composition of the present invention contains the first surfactant, whereby the aggregation of the pesticidal active compounds can be prevented.

The content of the first surfactant in the composition of the present invention is preferably 0.1 wt % or more, more preferably 0.5 wt % or more, and may be 1 wt % or more, and is preferably 20 wt % or less, more preferably 15 wt % or less, and may be 10 wt % or less and may be 7 wt % or less.

The composition of the present invention may further contain a second surfactant. The second surfactant is not particularly limited as long as it is a surfactant other than the first surfactant. Examples thereof include anionic surfactants, nonionic surfactants, cationic surfactants, amphoteric surfactants and mixtures thereof. A preferable second surfactant is a nonionic surfactant other than the first surfactant and/or an anionic surfactant.

Examples of the nonionic surfactant include polyoxyethylene alkyl ethers, polyoxypropylene alkyl ethers, polyoxyethylene polyoxypropylene alkyl ethers, polyoxyethylene distyryl phenyl ether, polyoxyethylene tristyryl phenyl ether, polyoxyethylene castor oil, sucrose fatty acid esters, sorbitan fatty acid esters, polyoxyethylene sorbitan fatty acid esters, glycerin fatty acid esters, polyoxyethylene fatty acid esters, polyoxyethylene alkylamines, alkylalkanolamides, and alkylpolyglycosides.

The anionic surfactant is, for example, a sulfonate, a sulfuric acid ester salt, a phosphoric acid ester salt, a carboxylate and a mixture thereof. Examples of the sulfonate include salts of naphthalenesulfonic acid or alkylnaphthalenesulfonic acids, salts of formalin condensates of naphthalenesulfonic acid or alkylnaphthalenesulfonic acids, alkylbenzenesulfonates, alkyl diphenyl ether disulfonates, α-olefinsulfonate, ligninsulfonate, polyoxyethylene alkyl phenyl ether sulfonates and dialkylsulfosuccinates. Examples of the sulfuric acid ester salt include alkylsulfuric acid ester salts, polyoxyethylene alkyl ether sulfuric acid ester salts and polyoxyethylene alkyl phenyl ether sulfuric acid ester salts. Examples of the phosphoric acid ester salt include polyoxyethylene alkyl aryl ether phosphoric acid ester salts and polyoxyethylene tristyryl phenyl ether phosphoric acid ester salts. Examples of the carboxylate include fatty acid salts and polycarboxylates such as polyacrylate. Examples of the counter ion of the anion group in the anionic surfactant include: alkali metal ions such as ions of sodium and potassium; alkaline earth metal ions such as ions of calcium and magnesium; ammonium ions; and organic ammonium ions derived from monoethanolamine, diethanolamine, or triethanolamine.

Preferable examples of the cationic surfactant include alkylamine salts and quaternary ammonium salts. Preferable examples of the amphoteric surfactant include alkylbetaines.

Preferable examples of the second surfactant include one or more surfactants selected from the following group (B):
group (B): the group consisting of acrylic acid-based polymers and salts thereof, ligninsulfonate, and salts of formalin condensates of naphthalenesulfonic acids optionally having an alkyl group.

The acrylic acid-based polymer included in the group (B) refers to a polymer constituted by one or more monomers having an acryloyl group, such as acrylic acid or methacrylic acid and their esters or amides. The type of the monomer is not particularly limited and may be one type or may be two or more types. The sequence of the monomer is not particularly limited, and examples thereof include random polymers, alternate polymers, block polymers, graft polymers, and star polymers.

Examples of the counter ion of the anion group in the second surfactant include: alkali metal ions such as ions of sodium and potassium; alkaline earth metal ions such as ions of calcium and magnesium; ammonium ion; and organic ammonium ion derived from monoethanolamine, diethanolamine, or triethanolamine.

One or more surfactants selected from the group (B) are used as the second surfactant, whereby the composition of the present invention can effectively prevent the aggregation of the pesticidal active compounds.

The content of the second surfactant in the composition of the present invention is preferably 0.1 wt % or more, more preferably 0.5 wt % or more, and may be 1 wt % or more, and is preferably 10 wt % or less, more preferably 7 wt % or less, and may be 5 wt % or less. When the second surfactant includes two or more surfactants, the content of the second surfactant refers to the total content thereof.

The content of the surfactant selected from the group (B) in the content of the second surfactant in the composition of the present invention is preferably 30 wt % or more, more preferably 50 wt % or more.

When the composition of the present invention contains the first surfactant and the second surfactant, the ratio between their contents is preferably 0.1 or more and may be 0.5 or more and may be 1 or more, and is preferably 10 or less and may be 7 or less and may be 5 or less, in terms of first surfactant/second surfactant.

The composition of the present invention contains water. Examples of the water include ion-exchange water, tap water and groundwater. The content of the water in the composition of the present invention is usually 30 wt % or more and may be 40 wt % or more and may be 50 wt % or more, and is usually 95 wt % or less and may be 90 wt % or less and may be 85 wt % or less.

The composition of the present invention may optionally contain other formulation aids. Examples of other formulation aids include thickeners, antifoaming agents, antifreezing agents, and antiseptics.

Examples of the thickener include polysaccharides such as xanthan gum, clay, and silicates. The content of the thickener in the composition of the present invention is usually 0.05 wt % or more and may be 0.07 wt % or more, and is usually 5 wt % or less and may be 3 wt % or less.

Examples of the antifoaming agent include silicone-based antifoaming agents. The content of the antifoaming agent in the composition of the present invention is usually 0.01 wt % or more and may be 0.05 wt % or more, and is usually 1 wt % or less and may be 0.5 wt % or less.

Examples of the antifreezing agent include ethylene glycol, propylene glycol, urea, and glycerin. The content of the antifreezing agent in the composition of the present invention is usually 1 wt % or more and may be 2 wt % or more, and is usually 10 wt % or less and may be 8 wt % or less.

Examples of the antiseptic include isothiazolinone-based antiseptics. The content of the antiseptic in the composition of the present invention is usually 0.05 wt % or more and may be 0.1 wt % or more, and is usually 0.5 wt % or less and may be 0.3 wt % or less.

The composition of the present invention can be produced, for example, using the first ingredient and the second ingredient which are pesticidal active ingredients, the hydrophobic organic solvent, the first surfactant, water and an optional second surfactant and formulation aid. When the first ingredient is contained in an oil phase and all the pesticidal active compounds included in the second ingredient are suspended in an aqueous phase, the composition of the present invention can be produced by, for example, the following methods.

(Method 1)

The first ingredient, the first surfactant, the hydrophobic organic solvent, and an optional formulation aid are added to water, and stirred and dispersed using a stirrer such as a homogenizer to prepare an emulsion. In this respect, the first surfactant may be added to the hydrophobic organic solvent, may be added to the water, or may be added to both. The second ingredient, the first surfactant and/or the second surfactant, and an optional formulation aid are added to water, and milled and suspended by wet milling using a medium such as glass beads or zirconia to prepare a suspension. Next, the emulsion, the suspension, and an optional formulation aid such as a thickener, an antiseptic, and an antifoaming agent are mixed to obtain the composition of the present invention.

(Method 2)

The first ingredient, the hydrophobic organic solvent, and an optional first surfactant and formulation aid are mixed to prepare an oil phase. The second ingredient, the first surfactant and/or the second surfactant, and an optional formulation aid are added to water to prepare an aqueous phase. The oil phase is added to the aqueous phase, and emulsified as well as milled and suspended at the same time by wet milling using a medium such as glass beads or zirconia, and the resultant is mixed with an optional formulation aid such as a thickener, an antiseptic, and an antifoaming agent to obtain the composition of the present invention.

(Method 3)

An emulsion is prepared by the same procedures as in method 1. To this emulsion, the second ingredient milled in advance by a dry milling method such as a hammer mill or an air mill, the first surfactant and/or the second surfactant, and an optional formulation aid such as a thickener, an antiseptic, and an antifoaming agent are added, and uniformly suspended to obtain the composition of the present invention.

The composition of the present invention can be used in the soil treatment of crop lands such as dry fields, orchard fields, pastures, lawn fields, and forestry fields; and non-crop lands such as levee slopes, riverbeds, shoulders and slopes of the roads, railroads, parks and green spaces, playgrounds, automobile parks, airports, and industrial plant sites such as factories and storage facilities as well as idle fields and urban deserts, thereby exerting an excellent herbicidal efficacy. In the case of cultivating a crop to which resistance to a herbicide has been imparted by introducing a herbicide resistance gene or the like, the composition of the present invention can be used in foliage treatment, thereby removing unfavorable plants.

Users prepare a spray liquid by usually mixing the composition of the present invention with water, and apply it from a knapsack sprayer, a spray tank, a spray plane, or an irrigation system. The amount of spray differs depending on climate conditions, the timing of treatment, soil conditions, target crops, target weeds, etc. and is usually 10 L or more and 2000 L or less, preferably 50 L or more and 400 L or less, per hectare. Also, the spray liquid is prepared by mixing the composition of the present invention with water in usually from 2 to 10000 times, preferably from 10 to 8000 times, more preferably from 15 to 6000 times the volume of the composition.

In applying the spray liquid, it may be mixed with an adjuvant. Although the type of the adjuvant is not particularly limited, it is desirable to mix an oil-based adjuvant (a mineral oil such as a paraffinic hydrocarbon, a naphthenic hydrocarbon, or an aromatic hydrocarbon, or a methylated seed oil in which a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant (polyoxyalkylene alkyl ether, polyoxyalkylene fatty acid ester, alkylaryl alkoxylate, or alkylaryl polyoxyalkylene glycol) such as Induce at 0.05%, 0.1%, 0.25%, or 0.5% (volume/volume) into the spray liquid. Other examples thereof include anionic adjuvant (substituted sulfonates) such as Gramin S, cationic adjuvant (polyoxyethyleneamine) such as Genamin T 200BM, and organic silicone-based adjuvant such as Silwet L77. Furthermore, a drift control agent such as Intact (polyethylene glycol) or a volatilization-reducing agent such as Vapex, a VaporGrip Xtra Agent (mixture of potassium hydroxide and acetic acid) may be mixed. The pH or hardness of the spray liquid is not particularly limited.

### Examples

In the following, the present invention will be described in further detail with reference to Examples and Comparative Examples, etc. The scope of the present invention is not limited to these Examples.

The products used in the preparation of liquid compositions will be given below.

(Organic Solvent)

Solvesso 200ND: Containing C10-C13 alkyl naphthalene as its main aromatic hydrocarbon, manufactured by ExxonMobil Chemical
JEFF SOL AG1705: Benzyl acetate, manufactured by Huntsman
Agnique AMD810: C8-C10 fatty acid dimethyl amide, manufactured by BASF

(Surfactant)

Stepflow 26F: Polyoxyethylene polyoxypropylene block copolymer, manufactured by Stepan
Alkamuls OR/40: Polyoxyethylene castor oil, manufactured by Solvay
Emulsogen TS290: Polyoxyethylene tristyryl phenyl ether, manufactured by Clariant
Toximul CA-7.5: Cocoamine ethoxylate, manufactured by Stepan
Phenylsulfonat CAL: Mixture of calcium dodecylbenzenesulfonate and iso-butanol, manufactured by Clariant
Soprophor FLK: Mixture of polyoxyethylene tristyryl phenyl ether phosphoric acid ester salt and propylene glycol, manufactured by Solvay
Atlox 4913: Acrylic acid-based polymer (graft polymer of methyl methacrylate and polyethylene glycol), manufactured by Croda
Reax 910: Sodium ligninsulfonate, manufactured by Ingevity
Morwet D-425: Sodium salt of a formalin condensate of an alkylnaphthalenesulfonic acid, manufactured by Nouryon
Atlox 4894: Mixture of nonionic surfactants, manufactured by Croda
Synperonic PE/F 127: Polyoxyethylene polyoxypropylene block copolymer, manufactured by Croda
Ethyl an NS-500LQ: Polyoxyethylene polyoxypropylene block copolymer, manufactured by Nouryon

(Thickener)

Kelzan S Plus: Xanthan gum, manufactured by CP Kelco
Veegum R: Magnesium aluminum silicate, manufactured by R.T. Vanderbilt Company. Inc

(Antifoaming Agent)

XIAMETER ACP-1500: Silicone-based mixture, manufactured by Dow Corning Toray Co., Ltd.

(Antifreezing Agent)

Propylene glycol: manufactured by Adeka

(Antiseptic)

Proxel GXL: 1,2-Benzisothiazolin-3-one, manufactured by Lonza

### Comparative Production Example 1

2.00 parts by weight of the compound (I) and 1.00 part by weight of Alkamuls OR/40 were mixed with 30.00 parts by weight of Solvesso 200ND to prepare 33.00 parts by weight of an oil phase. To 22.50 parts by weight of ion-exchange water, 0.07 parts by weight of XIAMETER ACP-1500 and 33.00 parts by weight of the prepared oil phase were added, and stirred and emulsified using a homogenizer (product name: TK Auto Homomixer, manufactured by Tokushu Kika Kogyo Co., Ltd.) to prepare 55.57 parts by weight of an emulsion (1) having a volume median diameter of 2.8 μm. The volume median diameter was measured using Mastersizer 2000 (manufactured by Spectris Co., Ltd.) under measurement conditions of particle shape: irregular, refractive index: 1.52, absorptance: 0.1, and dispersion medium: water (refractive index: 1.33). The measurement was also performed using the measurement apparatus and the measurement conditions described above as to volume median diameters described in Comparative Production Examples and Production Examples described below.

To 18.27 parts by weight of ion-exchange water, 0.20 parts by weight of Veegum R, 4.50 parts by weight of Propylene glycol, 0.07 parts by weight of XIAMETER ACP-1500, 1.00 part by weight of Soprophor FLK, and 7.00 parts by weight of flumioxazin were added, then stirred and mixed, and wet-milled using a bead mill (product name: DYNO-MILL, manufactured by Shinmaru Enterprises Corp., glass bead diameter: 1.0 mm, packing rate: 80%, circumferential velocity: 10 m/s) to obtain 31.04 parts by weight of a suspension (1) having a volume median diameter of 2.2 μm.

0.10 parts by weight of Kelzan S Plus, 0.20 parts by weight of Proxel GXL and 13.03 parts by weight of ion-exchange water were mixed to obtain 13.33 parts by weight of a thickener-containing liquid (1).

55.57 parts by weight of emulsion (1), 31.04 parts by weight of suspension (1), 13.33 parts by weight of thickener-containing liquid (1), and 0.06 parts by weight of XIAMETER ACP-1500 were mixed to obtain a liquid composition (hereinafter, called “comparative liquid composition 1”).

### Comparative Production Example 2

1.00 part by weight of the compound (I), 0.50 parts by weight of Emulsogen TS290, and 0.50 parts by weight of Phenylsulfonat CAL were mixed with 15.00 parts by weight of Solvesso 200ND to prepare 17.00 parts by weight of an oil phase. To 20.00 parts by weight of ion-exchange water, 0.07 parts by weight of XIAMETER ACP-1500 and 17.00 parts by weight of the prepared oil phase were added, and stirred and emulsified using a homogenizer (product name: TK Auto Homomixer, manufactured by Tokushu Kika Kogyo Co., Ltd.) to prepare 37.07 parts by weight of an emulsion (2) having a volume median diameter of 2.1 μm.

To 23.87 parts by weight of ion-exchange water, 0.40 parts by weight of Veegum R, 4.50 parts by weight of Propylene glycol, 0.07 parts by weight of XIAMETER ACP-1500, 3.00 parts by weight of Soprophor FLK, and 4.35 parts by weight of flumioxazin were added, then stirred and mixed, and wet-milled using a bead mill (product name: DYNO-MILL, manufactured by Shinmaru Enterprises Corp., glass bead diameter: 1.0 mm, packing rate: 80%, circumferential velocity: 10 m/s) to obtain 36.19 parts by weight of a suspension (2) having a volume median diameter of 2.3 μm.

0.20 parts by weight of Kelzan S Plus, 0.20 parts by weight of Proxel GXL and 26.28 parts by weight of ion-exchange water were mixed to obtain 26.68 parts by weight of a thickener-containing liquid (2).

37.07 parts by weight of emulsion (2), 36.19 parts by weight of suspension (2), 26.68 parts by weight of thickener-containing liquid (2), and 0.06 parts by weight of XIAMETER ACP-1500 were mixed to obtain a liquid composition (hereinafter, called “comparative liquid composition 2”). As a result of observing a liquid of comparative liquid composition 2 diluted 100-fold with water under a microscope, aggregates were confirmed.

### Comparative Production Example 3

An emulsion (3) having a volume median diameter of 1.3 μm was prepared by the same procedures as in Comparative Production Example 2 except that in the method for preparing emulsion (2) obtained in Comparative Production Example 2, 1.00 part by weight of Phenylsulfonat CAL was used instead of 0.50 parts by weight of Emulsogen TS290 and 0.50 parts by weight of Phenylsulfonat CAL, and 15.00 parts by weight of Agnique AMD810 were used instead of 15.00 parts by weight of Solvesso 200ND.

37.07 parts by weight of emulsion (3), 36.19 parts by weight of suspension (2) obtained by the same preparation method as in Comparative Production Example 2, 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “comparative liquid composition 3”).

### Comparative Production Example 4

An emulsion (4) having a volume median diameter of 1.3 μm was prepared by the same procedures as in Comparative Production Example 2 except that in the method for preparing emulsion (2) obtained in Comparative Production Example 2, 0.50 parts by weight of Toximul CA-7.5 were used instead of 0.50 parts by weight of Emulsogen TS290.

37.07 parts by weight of emulsion (4), 36.19 parts by weight of suspension (2) obtained by the same preparation method as in Comparative Production Example 2, 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “comparative liquid composition 4”). As a result of observing a liquid of comparative liquid composition 4 diluted 100-fold with water under a microscope, aggregates were confirmed.

### Comparative Production Example 5

An emulsion (5) having a volume median diameter of 1.7 μm was prepared by the same procedures as in Comparative Production Example 2 except that in the method for preparing emulsion (2) obtained in Comparative Production Example 2, 1.00 part by weight of Alkamuls OR/40 was used instead of 0.50 parts by weight of Emulsogen TS290 and 0.50 parts by weight of Phenylsulfonat CAL.

37.07 parts by weight of emulsion (5), 36.19 parts by weight of suspension (2) obtained by the same preparation method as in Comparative Production Example 2, 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “comparative liquid composition 5”).

### Comparative Production Example 6

A suspension (3) having a volume median diameter of 2.1 μm was prepared by the same procedures as in Comparative Production Example 2 except that in the method for preparing suspension (2) obtained in Comparative Production Example 2, 24.87 parts by weight of ion-exchange water were used instead of 23.87 parts by weight of ion-exchange water, and 2.00 parts by weight of Atlox 4913 were used instead of 3.00 parts by weight of Soprophor FLK.

37.07 parts by weight of emulsion (4) obtained by the same preparation method as in Comparative Production Example 4, 36.19 parts by weight of suspension (3), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “comparative liquid composition 6”). As a result of observing a liquid of comparative liquid composition 6 diluted 100-fold with water under a microscope, aggregates were confirmed.

### Comparative Production Example 7

A suspension (4) having a volume median diameter of 2.1 μm was prepared by the same procedures as in Comparative Production Example 2 except that in the method for preparing suspension (2) obtained in Comparative Production Example 2, 24.87 parts by weight of ion-exchange water were used instead of 23.87 parts by weight of ion-exchange water, and 2.00 parts by weight of Reax 910 were used instead of 3.00 parts by weight of Soprophor FLK.

37.07 parts by weight of emulsion (4) obtained by the same preparation method as in Comparative Production Example 4, 36.19 parts by weight of suspension (4), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “comparative liquid composition 7”). As a result of observing a liquid of comparative liquid composition 7 diluted 100-fold with water under a microscope, aggregates were confirmed.

### Production Example 1

1.00 part by weight of the compound (I) and 1.00 part by weight of Stepflow 26F were mixed with 15.00 parts by weight of Solvesso 200ND to prepare 17.00 parts by weight of an oil phase. To 20.00 parts by weight of ion-exchange water, 0.07 parts by weight of XIAMETER ACP-1500 and 17.00 parts by weight of the prepared oil phase were added, and stirred and emulsified using a homogenizer (product name: TK Auto Homomixer, manufactured by Tokushu Kika Kogyo Co., Ltd.) to prepare 37.07 parts by weight of an emulsion (6) having a volume median diameter of 1.5 μm.

To 24.87 parts by weight of ion-exchange water, 0.40 parts by weight of Veegum R, 4.50 parts by weight of Propylene glycol, 0.07 parts by weight of XIAMETER ACP-1500, 2.00 parts by weight of Stepflow 26F, and 4.35 parts by weight of flumioxazin were added, then stirred and mixed, and wet-milled using a bead mill (product name: DYNO-MILL, manufactured by Shinmaru Enterprises Corp., glass bead diameter: 1.0 mm, packing rate: 80%, circumferential velocity: 10 m/s) to obtain 36.19 parts by weight of a suspension (5) having a volume median diameter of 1.6 μm.

37.07 parts by weight of emulsion (6), 36.19 parts by weight of suspension (5), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 1”).

### Production Example 2

1.00 part by weight of the compound (I) was mixed with 15.00 parts by weight of Solvesso 200ND to prepare 16.00 parts by weight of an oil phase. To 20.00 parts by weight of ion-exchange water, 1.00 part by weight of Ethylan NS-500LQ, 0.07 parts by weight of XIAMETER ACP-1500, and 16.00 parts by weight of the prepared oil phase were added, and stirred and emulsified using a homogenizer (product name: TK Auto Homomixer, manufactured by Tokushu Kika Kogyo Co., Ltd.) to prepare 37.07 parts by weight of an emulsion (7) having a volume median diameter of 1.2 μm.

A suspension (6) having a volume median diameter of 2.0 μm was prepared by the same procedures as in Production Example 1 except that in the method for preparing suspension (5) obtained in Production Example 1, 2.00 parts by weight of Ethylan NS-500LQ were used instead of 2.00 parts by weight of Stepflow 26F.

37.07 parts by weight of emulsion (7), 36.19 parts by weight of suspension (6), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 2”).

### Production Example 3

1.00 part by weight of the compound (I) and 2.00 parts by weight of Stepflow 26F were mixed with 20.00 parts by weight of Solvesso 200ND to prepare 23.00 parts by weight of an oil phase. To 22.00 parts by weight of ion-exchange water, 0.07 parts by weight of XIAMETER ACP-1500 and 23.00 parts by weight of the prepared oil phase were added, and stirred and emulsified using a homogenizer (product name: TK Auto Homomixer, manufactured by Tokushu Kika Kogyo Co., Ltd.) to prepare 45.07 parts by weight of an emulsion (8) having a volume median diameter of 2.0 Jim.

To 15.87 parts by weight of ion-exchange water, 0.40 parts by weight of Veegum R, 4.50 parts by weight of Propylene glycol, 0.07 parts by weight of XIAMETER ACP-1500, 2.00 parts by weight of Atlox 4913, 1.00 part by weight of Atlox 4894, and 4.35 parts by weight of flumioxazin were added, then stirred and mixed, and wet-milled using a bead mill (product name: DYNO-MILL, manufactured by Shinmaru Enterprises Corp., glass bead diameter: 1.0 mm, packing rate: 80%, circumferential velocity: 10 m/s) to obtain 28.19 parts by weight of a suspension (7) having a volume median diameter of 2.4 μm.

45.07 parts by weight of emulsion (8), 28.19 parts by weight of suspension (7), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 3”).

### Production Example 4

A suspension (8) having a volume median diameter of 2.0 μm was obtained by the same procedures as in Production Example 3 except that in the method for preparing suspension (7) obtained in Production Example 3, 2.00 parts by weight of Reax 910 and 1.00 part by weight of Synperonic PE/F 127 were used instead of 2.00 parts by weight of Atlox 4913 and 1.00 part by weight of Atlox 4894.

45.07 parts by weight of emulsion (8) obtained in Production Example 3, 28.19 parts by weight of suspension (8), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 4”).

### Production Example 5

2.28 parts by weight of the compound (I) and 2.00 parts by weight of Stepflow 26F were mixed with 10.00 parts by weight of Solvesso 200ND and 4.00 parts by weight of JEFFSOL AG1705 to prepare 18.28 parts by weight of an oil phase. To parts by weight of ion-exchange water, 0.07 parts by weight of XIAMETER ACP-1500 and 18.28 parts by weight of the prepared oil phase were added, and stirred and emulsified using a homogenizer (product name: TK Auto Homomixer, manufactured by Tokushu Kika Kogyo Co., Ltd.) to prepare 38.35 parts by weight of an emulsion (9) having a volume median diameter of 2.4 μm.

To 13.17 parts by weight of ion-exchange water, 0.30 parts by weight of Veegum R, 4.50 parts by weight of Propylene glycol, 0.07 parts by weight of XIAMETER ACP-1500, 2.00 parts by weight of Atlox 4913, 1.00 part by weight of Atlox 4894, and 9.96 parts by weight of flumioxazin were added, then stirred and mixed, and wet-milled using a bead mill (product name: DYNO-MILL, manufactured by Shinmaru Enterprises Corp., glass bead diameter: 1.0 mm, packing rate: 80%, circumferential velocity: 10 m/s) to obtain 31.00 parts by weight of a suspension (9) having a volume median diameter of 2.1 μm.

0.15 parts by weight of Kelzan S Plus, 0.20 parts by weight of Proxel GXL, and 19.65 parts by weight of ion-exchange water were mixed to obtain 20.00 parts by weight of a thickener-containing liquid (3).

38.35 parts by weight of emulsion (9), 31.00 parts by weight of suspension (9), 20.00 parts by weight of thickener-containing liquid (3), 0.06 parts by weight of XIAMETER ACP-1500, and 10.59 parts by weight of ion-exchange water were mixed to obtain a liquid composition (hereinafter, called “present liquid composition 5”).

### Production Example 6

A suspension (10) having a volume median diameter of 2.2 μm was obtained by the same procedures as in Production Example 5 except that in the method for preparing suspension (9) obtained in Production Example 5, 2.00 parts by weight of Reax 910 and 1.00 part by weight of Synperonic PE/F 127 were used instead of 2.00 parts by weight of Atlox 4913 and 1.00 part by weight of Atlox 4894.

38.35 parts by weight of emulsion (9) obtained in Production Example 5, 31.00 parts by weight of suspension (10), 20.00 parts by weight of thickener-containing liquid (3) obtained by the same preparation method as in Production Example 5, 0.06 parts by weight of XIAMETER ACP-1500, and 10.59 parts by weight of ion-exchange water were mixed to obtain a liquid composition (hereinafter, called “present liquid composition 6”).

### Production Example 7

A suspension (11) having a volume median diameter of 2.2 μm was obtained by the same procedures as in Production Example 1 except that in the method for preparing suspension (5) obtained in Production Example 1, 23.87 parts by weight of ion-exchange water were used instead of 24.87 parts by weight of ion-exchange water, and 2.00 parts by weight of Morwet D-425 and 1.00 part by weight of Ethylan NS-500LQ were used instead of 2.00 parts by weight of Stepflow 26F.

37.07 parts by weight of emulsion (6) obtained in Production Example 1, 36.19 parts by weight of suspension (11), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 7”).

### Production Example 8

37.07 parts by weight of emulsion (6) obtained in Production Example 1, 36.19 parts by weight of suspension (3) obtained by the same preparation method as in Comparative Production Example 6, 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 8”).

### Production Example 9

37.07 parts by weight of emulsion (6) obtained in Production Example 1, 36.19 parts by weight of suspension (4) obtained by the same preparation method as in Comparative Production Example 7, 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 9”).

### Production Example 10

A suspension (12) having a volume median diameter of 2.0 μm was obtained by the same procedures as in Production Example 1 except that in the method for preparing suspension (5) obtained in Production Example 1, 2.00 parts by weight of Morwet D-425 were used instead of 2.00 parts by weight of Stepflow 26F.

37.07 parts by weight of emulsion (6) obtained in Production Example 1, 36.19 parts by weight of suspension (12), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 10”).

### Production Example 11

A suspension (13) having a volume median diameter of 2.0 μm was obtained by the same procedures as in Production Example 1 except that in the method for preparing suspension (5) obtained in Production Example 1, 2.00 parts by weight of Synperonic PE/F 127 were used instead of 2.00 parts by weight of Stepflow 26F.

37.07 parts by weight of emulsion (6) obtained in Production Example 1, 36.19 parts by weight of suspension (13), 26.68 parts by weight of thickener-containing liquid (2) obtained by the same preparation method as in Comparative Production Example 2, and 0.06 parts by weight of XIAMETER ACP-1500 were mixed to obtain a liquid composition (hereinafter, called “present liquid composition 11”).

### Test Example 1: Wet Sieving Test

10 g of the liquid composition immediately after production and after storage at a temperature of 54° C. for 2 weeks was weighed into a 300 mL beaker, to which 100 mL of tap water was then added and stirred for 5 minutes using a stirrer. The obtained suspension was transferred to a 100-mesh sieve, and tap water was further thoroughly passed therethrough. The resulting residues were recovered using ion-exchange water and dried. The proportion [%] of the residues was calculated from the weight of the residues thus dried. Provided that both the proportions of the residues immediately after production and after storage at a temperature of 54° C. for 2 weeks are less than 0.1% the aggregation of the pesticidal active compounds in the liquid composition is prevented and it can be evaluated as a formulation excellent in storage stability. Results of measuring the proportions of the residues immediately after production and after storage at a temperature of 54° C. for 2 weeks are shown in Table 1.

TABLE 1

| | | | | | Proportion of residue | |
|---|---|---|---|---|---|---|
| | | | | | in wet sieving test | |
| | | | | | Immediately | After storage |
| | | | | Thickener- | after | at 54° C. |
| | | | | containing | production | for 2 weeks |
| | Liquid composition | Emulsion | Suspension | liquid | [%] | [%] |
| Comparative | Comparative liquid | (1) | (1) | (1) | 0.044 | 0.243 |
| Example 1 | composition 1 | | | | | |
| Comparative | Comparative liquid | (2) | (2) | (2) | 2.437 | — |
| Example 2 | composition 2 | | | | | |
| Comparative | Comparative liquid | (3) | (2) | (2) | 0.039 | 0.157 |
| Example 3 | composition 3 | | | | | |
| Comparative | Comparative liquid | (4) | (2) | (2) | 3.288 | — |
| Example 4 | composition 4 | | | | | |
| Comparative | Comparative liquid | (5) | (2) | (2) | 0.063 | 0.730 |
| Example 5 | composition 5 | | | | | |
| Comparative | Comparative liquid | (4) | (3) | (2) | 0.380 | — |
| Example 6 | composition 6 | | | | | |
| Comparative | Comparative liquid | (4) | (4) | (2) | 0.153 | — |
| Example 7 | composition 7 | | | | | |
| Example 1 | Present liquid | (6) | (5) | (2) | 0.019 | 0.036 |
| | composition 1 | | | | | |
| Example 2 | Present liquid | (7) | (6) | (2) | 0.048 | 0.047 |
| | composition 2 | | | | | |
| Example 3 | Present liquid | (8) | (7) | (2) | 0.008 | 0.009 |
| | composition 3 | | | | | |
| Example 4 | Present liquid | (8) | (8) | (2) | 0.012 | 0.014 |
| | composition 4 | | | | | |
| Example 5 | Present liquid | (9) | (9) | (3) | 0.009 | 0.016 |
| | composition 5 | | | | | |
| Example 6 | Present liquid | (9) | (10) | (3) | 0.015 | 0.017 |
| | composition 6 | | | | | |
| Example 7 | Present liquid | (6) | (11) | (2) | 0.019 | 0.042 |
| | composition 7 | | | | | |
| Example 8 | Present liquid | (6) | (3) | (2) | 0.016 | 0.051 |
| | composition 8 | | | | | |
| Example 9 | Present liquid | (6) | (4) | (2) | 0.019 | 0.045 |
| | composition 9 | | | | | |
| Example 10 | Present liquid | (6) | (12) | (2) | 0.021 | 0.081 |
| | composition 10 | | | | | |
| Example 11 | Present liquid | (6) | (13) | (2) | 0.020 | 0.053 |
| | composition 11 | | | | | |

### Test Example 2

The weeds (Palmer amaranth (Amaranthus palmeri), narrow leaf Amaranthus (Amaranthus graecizanus), common ragweed (Ambrosia artemisiaefolia), giant ragweed (Ambrosia trifida), marestail (Conyza canadensis), common lambsquarters (Chenopodium album), Kochia (Kochia scoparia), common barnyardgrass (Echinochloa crus-galli) and giant foxtail (Setaria faberi)) are seeded to a plastic pot containing soil. On the same day, the surface of soil is treated with a mixture of any one of present liquid compositions 1 to 11, Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27), XtendiMAX Herbicide with VaporGrip Technology (dicamba diglycolamine salt, manufactured by Bayer, specific gravity: 1.2) and water. Their respective amounts in the treatment are 20 g/ha (in terms of the compound (I)) of the present liquid composition, 1232 g/ha of Agri-Dex, 742 g/ha of Intact, 1858 g/ha of Vapex, a VaporGrip Xtra Agent, and 1931 g/ha of XtendiMAX Herbicide with VaporGrip Technology, and the amount of the spray liquid is 140 L/ha. Then, they are cultivated in a greenhouse. Seven days later, soybean is seeded. Fourteen days later, a weed control effect and a crop injury to the soybean are investigated. In the case of using any of the formulations, an excellent weed control effect is confirmed.

### Test Example 3

The weeds (Palmer amaranth (Amaranthus palmeri), narrow leaf Amaranthus (Amaranthus graecizanus), common ragweed (Ambrosia artemisiaefolia), giant ragweed (Ambrosia trifida), marestail (Conyza canadensis), common lambsquarters (Chenopodium album), Kochia (Kochia scoparia), common barnyardgrass (Echinochloa crus-galli) and giant foxtail (Setaria faberi)) are seeded to a plastic pot containing soil. On the same day, the surface of soil is treated with a mixture of any one of present liquid compositions 1 to 11, Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27), XtendiMAX Herbicide with VaporGrip Technology (dicamba diglycolamine salt, manufactured by Bayer, specific gravity: 1.2) and water. Their respective amounts in the treatment are 20 g/ha (in terms of the compound (I)) of the present liquid composition, 1232 g/ha of Agri-Dex, 742 g/ha of Intact, 389 g/ha of Vapex, a VaporGrip Xtra Agent, and 1931 g/ha of XtendiMAX Herbicide with VaporGrip Technology, and the amount of the spray liquid is 140 L/ha. Then, they are cultivated in a greenhouse. Seven days later, soybean is seeded. Fourteen days later, a weed control effect and a crop injury to the soybean are investigated. In the case of using any of the formulations, an excellent weed control effect is confirmed.

1. A liquid composition comprising two or more pesticidal active compounds, a hydrophobic organic solvent, a first surfactant and water, wherein
the two or more pesticidal active compounds are a first ingredient which is a compound represented by the following formula (I), and a second ingredient consisting of one or more pesticidal active compounds that differ from the first ingredient, are poorly water-insoluble, and are solid at a temperature of 25° C.,
the first surfactant is a polyoxyethylene polyoxypropylene block copolymer, and
a liquid with the first ingredient dissolved or suspended in the hydrophobic organic solvent is dispersed in the water, and one or more pesticidal active compounds of the pesticidal active compounds included in the second ingredient are suspended in the water:

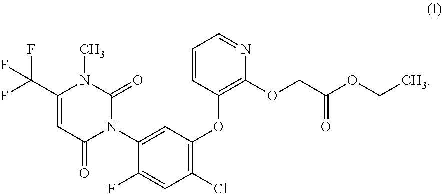

2. The liquid composition according to claim 1, wherein all the pesticidal active compounds included in the second ingredient are suspended in the water.

3. The liquid composition according to claim 1, wherein the second ingredient comprises one or more pesticidal active compounds selected from the following group (A):
group (A): the group consisting of flumioxazin and mesotrione.

4. The liquid composition according to claim 1, wherein the hydrophobic organic solvent comprises at least one of an aromatic hydrocarbon and benzyl acetate.

5. The liquid composition according to claim 1, further comprising a second surfactant, wherein
the second surfactant comprises one or more surfactants selected from the following group (B):
group (B): the group consisting of acrylic acid-based polymers and salts thereof, ligninsulfonate, and salts of formalin condensates of naphthalenesulfonic acids optionally having an alkyl group.
